(19) United States
(12) Patent Application Publication
(10) Pub. No.: US 2012/0203959 A1
(43) Pub. Date: Aug. 9, 2012

(54) NON-VOLATILE MEMORY, SYSTEM INCLUDING THE SAME, AND METHOD OF PROGRAMMING THE SAME

(75) Inventors: Hyun Jun Yoon, Seongnam-si (KR); Ki Tae Park, Seongnam-si (KR); Sang Yong Yoon, Seoul (KR); Seung-Hwan Shin, Ulsan (KR)

(73) Assignee: Samsung Electronics Co., Ltd., Suwon-si (KR)

(21) Appl. No.: 13/369,428

(22) Filed: Feb. 9, 2012

(30) Foreign Application Priority Data
Feb. 9, 2011 (KR) 10-2011-0011539

(51) Int. Cl. G06F 12/02

(52) U.S. Cl. 711/103; 711/E12.008

(57) ABSTRACT

A method of programming a non-volatile memory that includes dumping first page data loaded to a cache latch to a first data latch and backing up the first page data to a second data latch.

### CROSS-REFERENCE TO RELATED APPLICATIONS

This application claims priority under 35 U.S.C. §119(a) from Korean Patent Application No. 10-2011-0011539 filed on Feb. 9, 2011, the disclosure of which is hereby incorporated by reference in its entirety.

### BACKGROUND

1. Field

The present general inventive concept relates to a non-volatile memory, and more particularly, to a programming method by which data to be programmed to a flash memory is backed up to a latch of a page buffer in the flash memory, thereby reducing hardware cost and backup data-in time, and a device for performing the programming method.

The present general inventive concept also relates to a memory system, and more particularly, to a memory system for reducing hardware cost by transmitting different commands to a flash memory and a programming method of the memory system.

2. Description of the Related Art

Flash memory used as electrically erasable programmable read-only memory (EEPROM) has an advantage of random access memory (RAM) in which data can be readily programmed and erased and an advantage of ROM in which data can be retained without supply of power. Accordingly, flash memory is widely used as a storage medium in portable electronic devices such as digital cameras, personal digital assistants (PDAs), and MP3 players.

### SUMMARY

Some exemplary embodiments of the present general inventive concept provide a programming method to reduce hardware cost and backup data-in time by backing up data to be programmed to a flash memory to a latch of a page buffer in the flash memory

According to some exemplary embodiments of the present general inventive concept, there is provided a method of programming a non-volatile memory. The method includes dumping first page data loaded to a cache latch to a first data latch and backing up the first page data to a second data latch.

When programming the first page data that has been dumped to the first data latch to a first page of a first block fails, the method may further include copying back second page data programmed to a second page of the first block to a first page of a second block; and programming the first page data backed up to the second data latch to a second page of the second block.

The method may further include loading the first page data from a memory controller to the cache latch.

The method may further include resetting the second data latch before backing up the first page data to the second data latch.

The dump the first page data and the backup the first page data may be simultaneously performed.

The method may further include resetting the cache latch after the dump and the backup.

The method may further include loading another data to the cache latch during the programming after resetting the cache latch.

According to other exemplary embodiments of the present general inventive concept, there is provided a non-volatile memory including a page buffer comprising a cache latch, a first data latch, and a second data latch; and a control logic configured to control the page buffer to dump first page data loaded to the cache latch to the first data latch and back up the first page data to the second data latch.

Further, the non-volatile memory may include a memory cell array configured to store the first page data and the second page data.

When programming the first page data dumped to the first data latch to a first page of a first block fails, the control logic may control the page buffer to copy back the second page data programmed to a second page of the first block to a first page of a second block and program the first page data backed up to the second data latch to a second page of the second block.

The control logic may control the page buffer to reset the second data latch before backing up the first page data to the second data latch.

The control logic may control the page buffer to simultaneously perform the dump of the first page data to the first data latch and the backup of the first page data to the second data latch.

The control logic may control the page buffer to reset the cache latch after the dump and the backup.

The control logic may control the page buffer to load another data to the cache latch during the programming after resetting the cache latch.

According to further exemplary embodiments of the present general inventive concept, there is provided a memory system including the above-described non-volatile memory and a memory controller configured to control the non-volatile memory.

When programming the first page data dumped to the first data latch to a first page of a first block fails, the control logic may control the page buffer to copy back the second page data programmed to a second page of the first block to a first page of a second block and program the first page data backed up to the second data latch to a second page of the second block.

The control logic may control the page buffer to reset the second data latch before backing up the first page data to the second data latch.

The memory controller may load the first page data to the cache latch.

The control logic may control the page buffer to simultaneously perform the dump of the first page data to the first data latch and the backup of the first page data to the second data latch.

The control logic may control the page buffer to reset the cache latch after the dump and the backup.

The memory system may be a smart card, a solid state drive, or a tablet personal computer

Additional features and utilities of the present general inventive concept will be set forth in part in the description which follows and, in part, will be obvious from the description, or may be learned by practice of the general inventive concept.

### BRIEF DESCRIPTION OF THE DRAWINGS

The above and other features and utilities of the present general inventive concept will become apparent and more readily appreciated from the following description of the exemplary embodiments with reference to the attached drawings in which:

FIG. 1 is a block diagram of the schematic structure of a memory device according to some exemplary embodiments of the present general inventive concept;

FIG. 2 is a block diagram of the schematic structure of a flash memory illustrated in FIG. 2;

FIG. 3 is a block diagram of the schematic structure of one of pages buffers illustrated in FIG. 2;

FIG. 4 is a sequence diagram showing the operation of programming page data according to some exemplary embodiments of the present general inventive concept;

FIG. 5 is a sequence diagram showing the operation of programming page data according to other exemplary embodiments of the present general inventive concept;

FIG. 6 is a flowchart showing the programming operations of the memory device illustrated in FIG. 1;

FIG. 7 is a block diagram of an electronic device including the flash memory illustrated in FIG. 1 according to some exemplary embodiments of the present general inventive concept;

FIG. 8 is a block diagram of an electronic device including the flash memory illustrated in FIG. 1 according to other exemplary embodiments of the present general inventive concept;

FIG. 9 is a block diagram of an electronic device including the flash memory illustrated in FIG. 1 according to further exemplary embodiments of the present general inventive concept; and

FIG. 10 is a diagram showing commands input through an input/output data bus and the operations of the electronic device illustrated in FIG. 9 according to the commands

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments may, however, be embodied in many different forms and should not be construed as limited to the exemplary embodiments set forth herein. In the drawings, the size and relative sizes of layers and regions may be exaggerated for clarity. The exemplary embodiments are described below in order to explain the present general inventive concept while referring to the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular exemplary embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

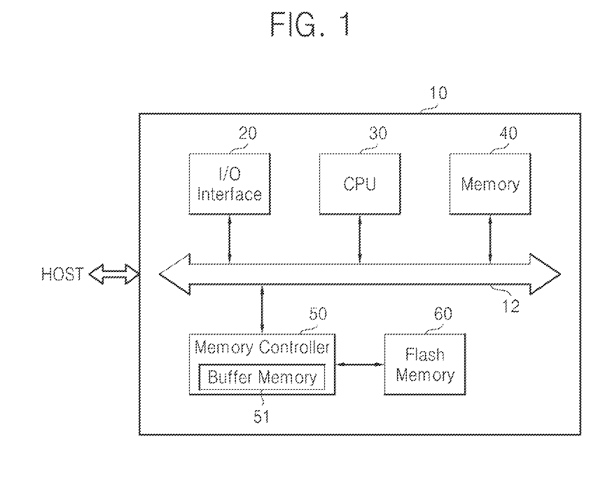

FIG. 1 is a block diagram of the schematic structure of a memory device 10 according to some exemplary embodiments of the present general inventive concept. The memory device 10 may include an input/output (I/O) interface 20, a central processing unit (CPU) 30, a memory 40, a memory controller 50, and a flash memory 60.

The I/O interface 20 interfaces a host HOST and the memory device 10 for data exchange. The I/O interface 20 receives a program command or data corresponding to the program command from the host HOST. The I/O interface 20 also transmits the program command or data output from the host HOST to the CPU 30 via a data bus 12.

The CPU 30 controls the overall operation of the memory device 10. The CPU 30 may control data exchange between the host HOST and the I/O interface 20. The CPU 30 also controls the memory device 10 to perform an operation corresponding to a command received from the host HOST. The CPU 30 receives a program command or data corresponding to the program command from the host HOST via the data bus 12. The CPU 30 may control the memory device 10 to program the data corresponding to the program command to the memory 40 or the flash memory 60.

The CPU 30 may transmit a program command or a control signal for programming data to the memory controller 50 so that the data is programmed to the flash memory 60. At this time, the flash memory 60 may program the data corresponding to the program command to a memory cell array under the control of the memory controller 50.

The memory 40 stores various types of data for controlling the operation of the memory device 10. The CPU 30 may store a program command output from the host HOST or data output from the host HOST in correspondence to the program command in the memory 40. The memory 40 may be implemented by a non-volatile memory, e.g., read-only memory (ROM), for storing program codes for controlling the operation of the CPU 30 or may be implemented by a volatile memory, e.g., dynamic random access memory (DRAM), for storing data transmitted between the host HOST and the CPU 30.

The memory controller 50 controls the operation of the flash memory 60. The memory controller 50 includes a buffer memory 51 which stores page data to be programmed to the flash memory 60. The buffer memory 51 may be implemented by a volatile memory such as static random access memory (SRAM).

The flash memory 60 is a non-volatile memory. The flash memory 60 includes a plurality of blocks each of which includes a plurality of pages. The flash memory 60 stores various types of data under the control of the memory controller 50.

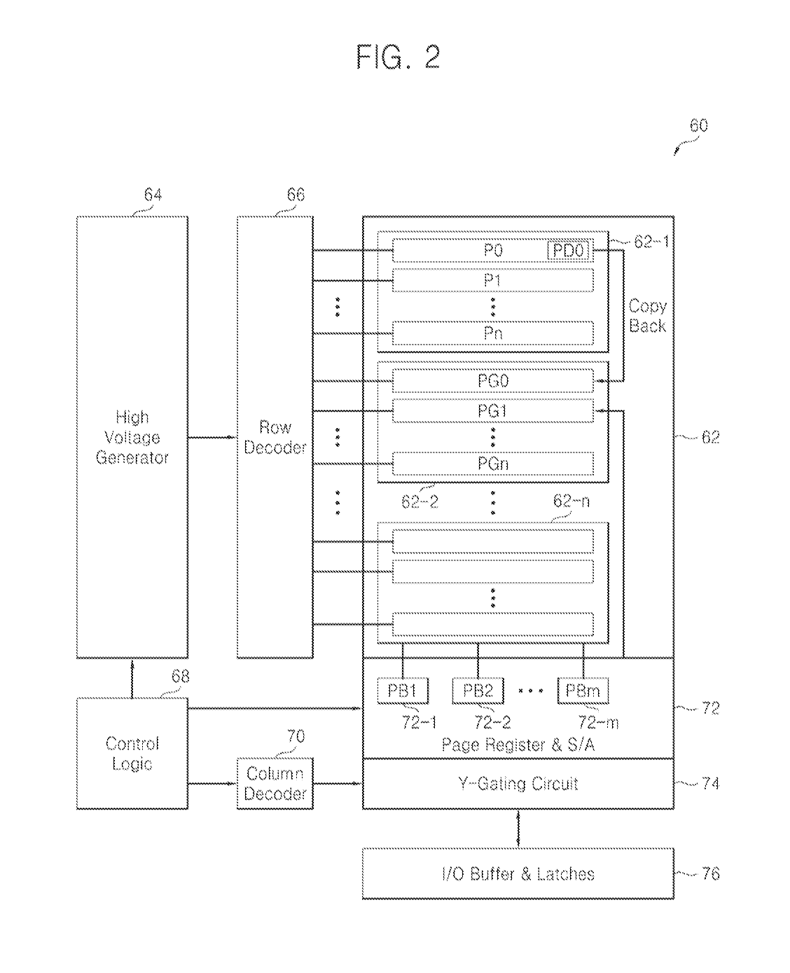

FIG. 2 is a block diagram of the schematic structure of the flash memory 60 illustrated in FIG. 2. The flash memory 60 includes a memory cell array 62, a high voltage generator 64, a row decoder 66, a control logic 68, a column decoder 70, a page register and sense amplifier (S/A) block 72, a Y-gating circuit 74, and an I/O buffer and latches block 76.

The memory cell array 62 includes a plurality of blocks 62-1, 62-2, . . . , 62-n. Each (e.g., 62-1) of the blocks 62-1 through 62-n includes a plurality of pages (e.g., P0, P1, Pn where “n” is a natural number). The programming operation of the flash memory 60 is performed in units of pages and each of the pages (e.g., P0 through Pn) includes a plurality of memory cells (not shown).

The memory cells may be embodied or disposed on one plane in two dimensions or on different planes or layers in three dimensions.

Each of the memory cells may be implemented by an electrically erasable programmable read-only memory (EEPROM) cell that can store one or more bits. Each memory cell may be implemented by a NAND flash memory cell storing one bit, e.g., single level cell (SLC), or a NAND flash memory cell storing more than one bit, e.g., multi-level cell (MLC).

According to the control of the control logic 68, the high voltage generator 64 generates a plurality of voltages including a program voltage needed to perform a program operation, a plurality of voltages including a read voltage needed to perform a read operation, a plurality of voltages including a verify voltage needed to perform a verify operation, or a plurality of voltages including an erase voltage needed to perform an erase operation, and outputs the voltages needed to perform each operation to the row decoder 66.

The control logic 68 may control the operations of the high voltage generator 64, the column decoder 70, and the page register and S/A block 72 according to an external command such as a program command, a read command, or an erase command.

The page register and S/A block 72 includes a plurality of page buffers 72-1, 72-2, . . . , 72-m. Each of the page buffers 72-1 through 72-m operates as a driver for programming data to the memory cell array 62 in a program operation under the control of the control logic 68.

Each of the page buffers 72-1 through 72-m also operates as an S/A which identifies a threshold voltage of a selected memory cell among a plurality of memory cells in the memory cell array 62 in a read or verify operation under the control of the control logic 68.

The column decoder 70 decodes column addresses and outputs decoded signals to the Y-gating circuit 74 under the control of the control logic 68. The Y-gating circuit 74 may control data transmission between the page register and S/A block 72 and the I/O buffer and latches block 76 in response to the decoded signals received from the column decoder 70. The I/O buffer and latches block 76 may transmit data to the Y-gating circuit 74 or to an outside via a data bus.

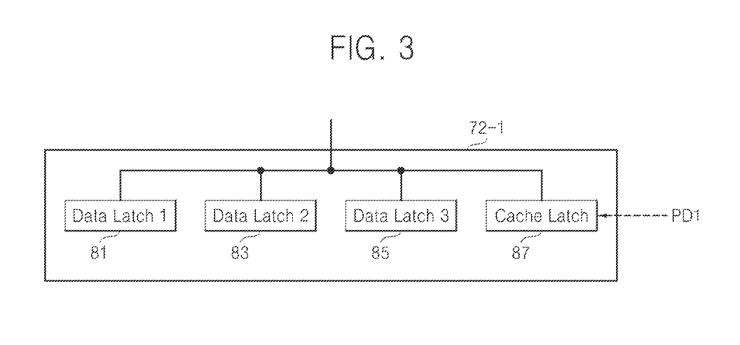

FIG. 3 is a block diagram of the schematic structure of one page buffer 72-1 among the page buffers 72-1 through 72-m illustrated in FIG. 2. Referring to FIGS. 1 through 3, the page buffer 72-1 includes a plurality of data latches 81, 83, and 85 and a cache latch 87.

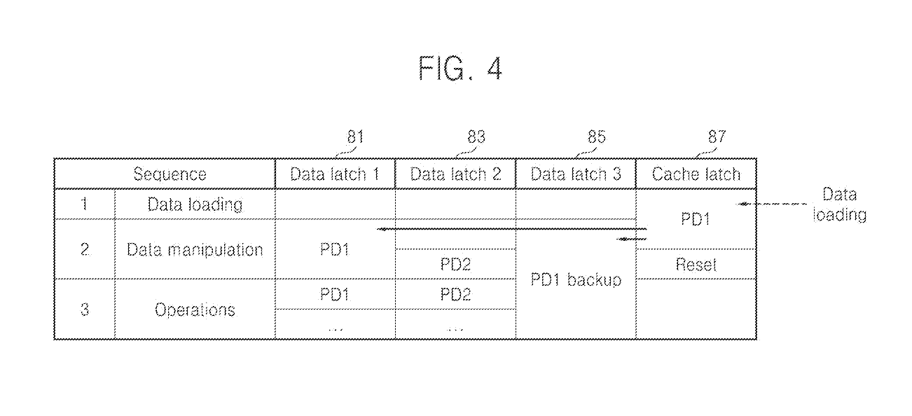

FIG. 4 is a sequence diagram showing the operation of programming page data according to some embodiments of the present general inventive concept. Referring to FIGS. 1 through 4, when each of the memory cells is implemented by an MLC storing two bits, the data latch 83 may latch least significant bit (LSB) page data and the data latch 81 may latch most significant bit (MSB) page data. After the LSB page data is programmed to the memory cells, the MSB page data is programmed to the memory cells. The programming order may be different in other embodiments.

It is assumed that page data PD0 has been successfully programmed to the page P0 in the block 62-1. Page data PD1 is loaded from the buffer memory 51 in the memory controller 50 to the cache latch 87.

After the data loading, the page data PD1 loaded to the cache latch 87 is dumped to the data latch 81. In addition, the page data PD1 loaded to the cache latch 87 is backed up to the remaining data latch 85.

The data latch 83 latches page data PD2 programmed to the page P1 of the block 62-1 so that the page data PD1 is programmed to the page P1 of the block 62-1. The page data PD1 may be MSB page data and the page data PD2 may be LSB page data. The dumping operation and the backup operation can be performed simultaneously.

The cache latch 87 is reset to get new page data loaded. This procedure is data manipulation. After the data manipulation, an operation of programming the page data PD1 loaded to the data latch 81 and the page data PD2 loaded to the data latch 83 to the page P1 of the block 62-1 may be performed. During the operation, new page data may be loaded to the cache latch 87.

When the programming of the page data PD1 and the page data PD2 to the page P1 of the block 62-1 fails, the page data PD0 programmed to the page P0 of the block 62-1 is copied back to a page PG0 of the block 62-2. After the copy-back operation, the page data PD1 does not need to be loaded from the memory controller 50 since the page data PD1 has been backed up to the data latch 85. In other words, backup data-in time is not needed. Then, the flash memory 60 programs the page data PD1 in the data latch 85 to the page PG1 of the block 62-2.

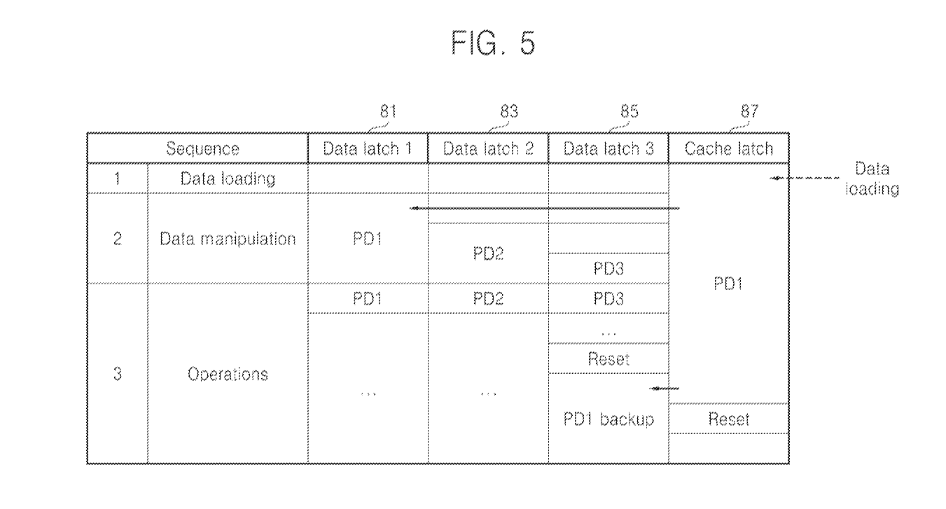

FIG. 5 is a sequence diagram showing the operation of programming page data according to other exemplary embodiments of the present general inventive concept. Referring to FIGS. 1 through 3 and FIG. 5, when each of the memory cells is implemented by an MLC storing three bits, the data latch 85 may latch LSB page data, the data latch 83 may latch center significant bit (CSB) page data, and the data latch 81 may latch MSB page data. Data may be programmed to the memory cells in order of LSB, CSB, and MSB.

It is assumed that page data PD0 has been successfully programmed to the page P0 in the block 62-1. Page data PD1 is loaded from the buffer memory 51 in the memory controller 50 to the cache latch 87. After the data loading, the page data PD1 loaded to the cache latch 87 is dumped to the data latch 81.

The data latch 85 latches page data PD3 programmed to the page P1 of the block 62-1 so that the page data PD1 is programmed to the page P1 of the block 62-1. In addition, the data latch 83 latches the page data PD2 programmed to the page P1 of the block 62-1. This procedure is data manipulation.

The page data PD1 may be MSB page data, the page data PD2 may be CSB page data, and the page data PD3 may be LSB page data. After the data manipulation, an operation of programming the page data PD1 to the page P1 of the block 62-1 together with the page data PD2 and the page data PD3.

During the program operation, the data latch 85 is reset. After the reset, the page data PD1 loaded to the cache latch 87 is backed up to the data latch 85. During the program operation, new page data may be loaded to the cache latch 87.

When the programming of the page data PD1 and the page data PD2 to the page P1 of the block 62-1 fails, the page data PD0 programmed to the page P0 of the block 62-1 is copied back to the page PG0 of the block 62-2. After the copy-back operation, the flash memory 60 programs the page data PD1 that has been backed up to the data latch 85 to the page PG1 of the block 62-2.

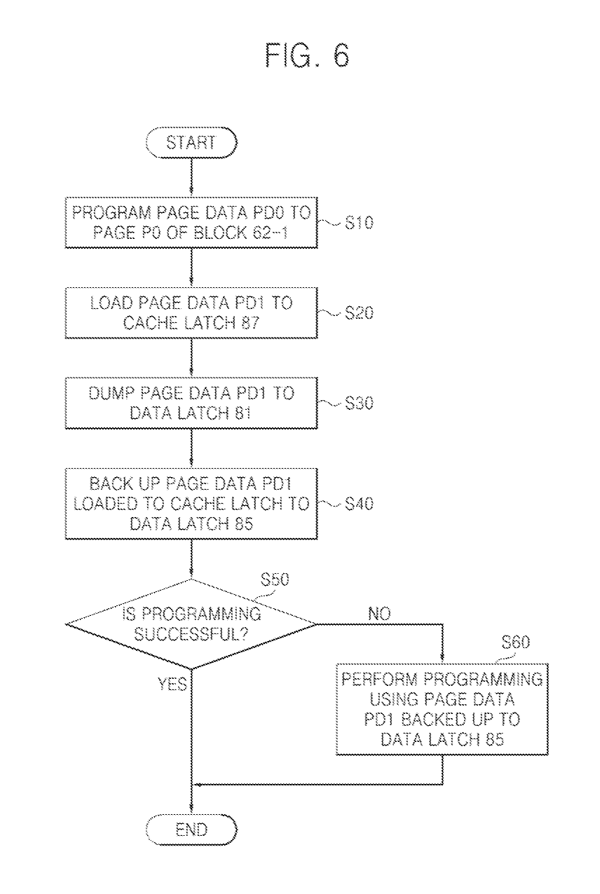

FIG. 6 is a flowchart showing the programming operations of the memory device 10 illustrated in FIG. 1. Referring to FIGS. 1 through 4 and FIG. 6, the flash memory 60 programs the page data PD0 to the page P0 of the block 62-1 in operation S10.

The page data PD1 is loaded from the buffer memory 51 in the memory controller 50 to the cache latch 87 in operation S20. The page data PD1 loaded to the cache latch 87 is dumped to the data latch 81 in operation S30. The page data PD1 loaded to the cache latch 87 is backed up to the data latch 85 in operation S40. The dumping operation (S30) and the backup operation (S40) may be performed at the same time.

The flash memory 60 programs the page data PD1 latched by the data latch 81 to the page P1 of the block 62-1. The flash memory 60 determines whether the page data PD1 has been successfully programmed to the page P1 of the block 62-1 in operation S50. When it is determined that the programming has failed, the flash memory 60 programs the page data PD1 backed up to the data latch 85 to the page PG1 of the block 62-2 in operation S60.

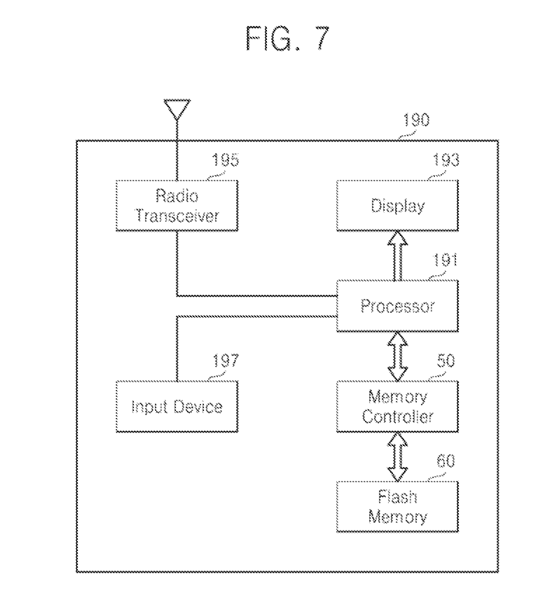

FIG. 7 is a block diagram of an electronic device 190 including the flash memory 60 illustrated in FIG. 1 according to some exemplary embodiments of the present general inventive concept. Referring to FIG. 7, the electronic device 190 is a memory system that may be implemented as, for example, a cellular phone, a smart phone, a wireless Internet system, a personal computer (PC), a tablet PC, a lap-top computer, an electronic reader (e-reader), a PDA, a portable multimedia player (PMP), an MP3 player, an MP4 player, a digital camera, etc. The electronic device 190 may include the flash memory 60 and a memory controller 50 controlling the operation of the flash memory 60. The memory controller 50 may be controlled by a processor 191 which controls the overall operation of the electronic device 190. The flash memory 60 may perform a page data backup operation.

Data stored in the flash memory 60 may be displayed through a display 193 under the control of the processor 191. A radio transceiver 195 may transmit or receive radio signals through an antenna. The radio transceiver 195 may convert radio signals received through the antenna into signals that can be processed by the processor 191. Accordingly, the processor 191 may process the signals output from the radio transceiver 195 and store the processed signals in the flash memory 60 or display them through the display 193. The radio transceiver 195 may also convert signals output from the processor 191 into radio signals and outputs the radio signals to an outside through the antenna.

An input device 197 enables control signals for controlling the operation of the processor 191 or data to be processed by the processor 191 to be input to the electronic device 190. The input device 197 may be implemented by a pointing device such as, for example, a touch pad, a computer mouse, a keypad, a keyboard, etc.

The processor 191 may control the operation of the display 193 to display data output from the flash memory 60, radio signals output from the radio transceiver 195, or data output from the input device 197.

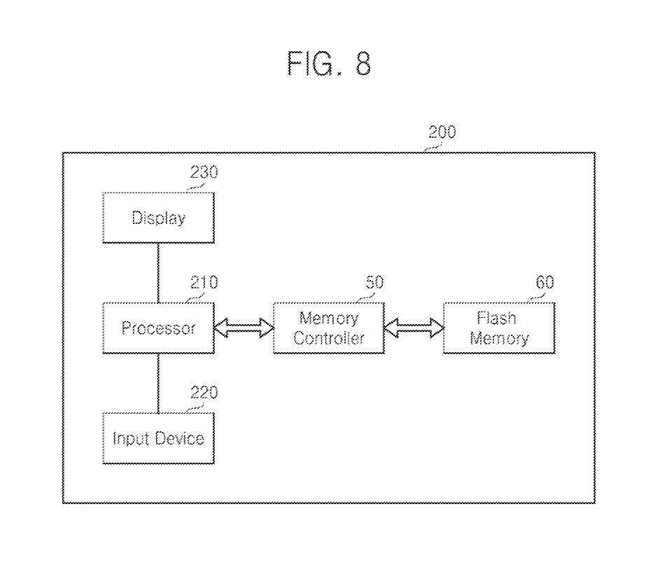

FIG. 8 is a block diagram of an electronic device 200 including the flash memory 60 illustrated in FIG. 1 according to other exemplary embodiments of the present general inventive concept. Referring to FIG. 8, the electronic device 200 is a memory system that may be implemented as, for example, a personal computer (PC), a tablet PC, a lap-top computer, an e-reader, a PDA, a portable multimedia player (PMP), an MP3 player, an MP4 player, digital camera, etc. The electronic device 200 may include the flash memory 60 and the memory controller 50 that may control the operation of the flash memory 60.

The flash memory 60 may perform a page data backup operation. The electronic device 200 may also include a processor 210 that may control the overall operation of the electronic device 200. The memory controller 50 may be controlled by the processor 210 that controls the overall operation of the electronic device 200. The processor 210 may display data stored in the flash memory 60 through a display 230 according to an input signal generated by an input device 220. The input device 220 may be implemented by a pointing device such as, for example, a touch pad, a computer mouse, a keypad, a keyboard, etc.

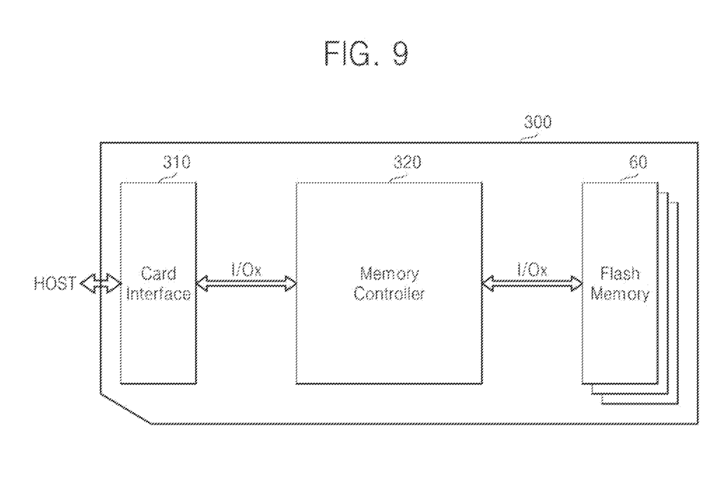

FIG. 9 is a block diagram of an electronic device 300 including the flash memory 60 illustrated in FIG. 1 according to further exemplary embodiments of the present general inventive concept. Referring to FIG. 9, the electronic device 300 may be a memory system and may include a card interface 310, a memory controller 320, and at least one flash memory 60.

The electronic device 300 may communicate data with a host HOST through the card interface 310. The card interface 310 may be, for example, a secure digital (SD) card interface or a multi-media card (MMC) interface, but the present general inventive concept should not be limited to these exemplary interfaces. The card interface 310 may interface the host HOST and the memory controller 320 for data exchange according to a communication protocol of the host HOST through which the host HOST can communicate with the electronic device 300.

The memory controller 320 may control overall operation of the electronic device 300 and control data exchange between the card interface 310 and the flash memory 60. The memory controller 320 may be connected with the card interface 310 and the flash memory 60 through an input/output data bus I/Ox. The memory controller 320 may receive an address of data to be read or written from the card interface 310 through the input/output data bus I/Ox and may transmit the address to the flash memory 60 through the input/output data bus I/Ox.

The flash memory 60 may store data. Further, a read operation and a write operation may be simultaneously performed in the flash memory 60. Additionally, a memory cell array at which the read operation is performed may be different from a memory cell array at which the write operation is performed in the flash memory 60.

When the electronic device 300 is connected with the host HOST such as, for example, a computer, a digital camera, a digital audio player, a cellular phone, a console video game hardware, or a digital set-top box, the host HOST may transmit data to, or receive data from, the flash memory 60 through the card interface 310 and the memory controller 320.

The flash memory 60 and the memory controller 320 may be implemented in a single chip and the electronic device 300 may be a memory device.

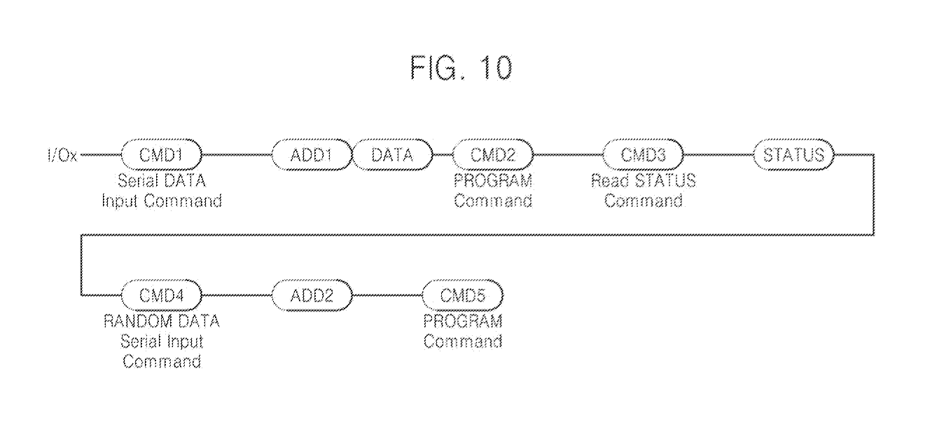

FIG. 10 is a diagram showing commands input through an input/output data bus and the operations of the electronic device 300 illustrated in FIG. 9 according to the commands. Referring to FIGS. 2, 9, and 10, the page buffers 72-1 through 72-m in the flash memory 60 receive a serial data input command CMD1 from the memory controller 320 through the input/output data bus I/Ox.

After the serial data input command CMD1 is received, an address ADD1 of the memory cell array 62 and page data DATA are received. The address ADD1 of the memory cell array 62 is an address to which the page data DATA will be programmed, e.g., an address of the page P0 of the block 62-1.

Upon receiving the serial data input command CMD1, data latches in the page buffers 72-1 through 72-m are all reset to “1”. Accordingly, only data to be programmed to “0” is received.

After the address ADD1 and the page data DATA are received, a program command CMD2 for programming the page data DATA to the address ADD1 is received. Upon receiving the program command CMD2, a program operation starts. After the program operation, a read status command CMD3 is received to confirm whether the page data DATA has been successfully programmed in the address ADD1.

In conventional art, when a program operation fails, a new serial data input command is received and all data latches in the page buffers are reset to “1” in response to the new serial data input command. Accordingly, when the new serial data input command is received in the conventional art, the page data also needs to be received again. As a result, an additional buffer memory in which page data is backed up by a memory controller is required.

However, in the exemplary embodiments of the present general inventive concept, when the program operation fails, a random data serial input command CMD4 is received. After the random data serial input command CMD4 is received, only an address ADD2 is received. The address ADD2 is an address to which the page data DATA will be programmed, e.g., an address of the page PG0 of the block 62-2.

Unlike the serial data input command CMD1, the random data serial input command CMD4 does not reset the data latches in the page buffers 72-1 through 72-m. In other words, even when the random data serial input command CMD4 is received, the page buffers 72-1 through 72-m still retain the page data DATA. As a result, an additional buffer memory for the backup of the page data DATA is not needed. Further, after the address ADD2 is received, a program command CMD5 for programming the page data DATA to the address ADD2 is received and a program operation is performed.

According to the exemplary embodiments of the present general inventive concept, a flash memory may back up data to be programmed to a latch of a page buffer in the flash memory, thereby reducing hardware cost and backup data-in time. In addition, according to the exemplary embodiments of the present general inventive concept, a memory system may transmit different commands to the flash memory, thereby reducing hardware cost.

While the present general inventive concept has been particularly shown and described with reference to various exemplary embodiments, it will be appreciated by those of ordinary skill in the art that various changes in forms and details may be made therein without departing from the spirit and scope of the present general inventive concept as defined by the following claims and their equivalents.

1. A method of programming a non-volatile memory, the method comprising:
dumping first page data loaded to a cache latch to a first data latch; and
backing up the first page data to a second data latch.

2. The method of claim 1, further comprising:
when programming the first page data having been dumped to the first data latch to a first page of a first block fails, copying back second page data programmed to a second page of the first block to a first page of a second block; and
programming the first page data backed up to the second data latch to a second page of the second block.

3. The method of claim 1, further comprising loading the first page data from a memory controller to the cache latch.

4. The method of claim 1, further comprising resetting the second data latch before backing up the first page data to the second data latch.

5. The method of claim 1, wherein the dump the first page data and the backup the first page data are simultaneously performed.

6. A non-volatile memory comprising:
a memory cell array configured to store first page data and second page data;
a page buffer including a cache latch, a first data latch, and a second data latch; and
a control logic configured to control the page buffer to dump the first page data loaded to the cache latch to the first data latch and to back up the first page data to the second data latch.

7. The non-volatile memory of claim 6, wherein, when programming the first page data having been dumped to the first data latch to a first page of a first block fails, the control logic controls the page buffer to copy back the second page data programmed to a second page of the first block to a first page of a second block and to program the first page data backed up to the second data latch to a second page of the second block.

8. The non-volatile memory of claim 6, wherein the control logic controls the page buffer to reset the second data latch before backing up the first page data to the second data latch.

9. The non-volatile memory of claim 6, wherein the control logic controls the page buffer to simultaneously perform the dump of the first page data to the first data latch and the backup of the first page data to the second data latch.

10. A memory system comprising:
a non-volatile memory including:
a memory cell array configured to store first page data and second page data;
a page buffer including a cache latch, a first data latch, and a second data latch; and
a control logic configured to control the page buffer to dump the first page data loaded to the cache latch to the first data latch and to back up the first page data to the second data latch; and
a memory controller configured to control the non-volatile memory.

11. The memory system of claim 10, wherein, when programming the first page data having been dumped to the first data latch to a first page of a first block fails, the control logic controls the page buffer to copy back the second page data programmed to a second page of the first block to a first page of a second block and to program the first page data backed up to the second data latch to a second page of the second block.

12. The memory system of claim 10, wherein the control logic controls the page buffer to reset the second data latch before backing up the first page data to the second data latch.

13. The memory system of claim 10, wherein the memory controller loads the first page data to the cache latch.

14. The memory system of claim 10, wherein the control logic controls the page buffer to simultaneously perform the dump of the first page data to the first data latch and the backup of the first page data to the second data latch.

15. The memory system of claim 10, wherein the memory system is a smart card, a solid state drive (SSD), or a tablet personal computer (PC)

16-19. (canceled)
